(19) United States
(12) Patent Application Publication
(10) Pub. No.: US 2009/0248660 A1
(43) Pub. Date: Oct. 1, 2009

(54) BUNDLING OF QUERY-RELATED CONTEXT FOR SPONSORED SEARCH

(75) Inventors: Arpita Ghosh, Santa Clara, CA (US); Hamid Nazerzadeh, Stanford, CA (US)

Correspondence Address: FIALA & WEAVER, P.L.L.C.;C/O CPA GLOBAL, P.O. BOX 52050, MINNEAPOLIS, MN, 55402, US

(73) Assignee: Yahoo! Inc., Sunnyvale, CA (US)

(21) Appl. No.: 12/057,081

(22) Filed: Mar. 27, 2008

(51) Int. Cl. G06F 17/30

(52) U.S. Cl. 707/5; 707/E17.108

(57) ABSTRACT

A sponsored search auction system is configured to receive bids for queries from advertisers. Each bid on a particular query relates to a particular context, such as an age, sex, or location of a user that may submit the query to a search engine. A valuation is provided for each available context of the query by each advertiser. The bids are processed to generate one or more context bundles. The context bundles are groupings of contexts. Not necessarily all contexts are bundled. The bundled and unbundled (if present) contexts may be sold to the advertisers as bundled. Selling of contexts in bundled form may enable increased revenue to be generated as compared to auction systems that sell each context separately or sell contexts bundled into a single group.

### BACKGROUND OF THE INVENTION

1. Field of the Invention

The present invention relates to online advertising, and in particular, to search engine-related advertising.

2. Background Art

A search engine is an information retrieval system used to locate documents and other information stored on a computer system. Search engines are useful at reducing an amount of time required to find information. One well known type of search engine is a Web search engine which searches for documents, such as web pages, on the “World Wide Web.” Examples of such search engines include Yahoo! Search™ (at http://www.yahoo.com), Ask.com™ (at http://www.ask.com), and Google™ (at http://www.google.com). Online services such as LexisNexis™ and Westlaw™ also enable users to search for documents provided by their respective services, including articles and court opinions. Further types of search engines include personal search engines, mobile search engines, and enterprise search engines that search on intranets, among others.

To perform a search, a user of a search engine supplies a query to the search engine. The query contains one or more words/terms, such as “hazardous waste” or “country music.” The terms of the query are typically selected by the user to as an attempt find particular information of interest to the user. The search engine returns a list of documents relevant to the query. In a Web-based search, the search engine typically returns a list of uniform resource locator (URL) addresses for the relevant documents, which is displayed to the user in a search results page. If the scope of the search resulting from a query is large, the returned list of documents may include thousands or even millions of documents.

“Sponsored search” refers to a form of Internet advertising/marketing that enables advertisers to increase their visibility in the results page of a search engine query. According to sponsored search, an advertiser may pay or provide other compensation for having an advertisement appear in a sponsored section of the results page for one or more particular queries. A user who enters one of the queries into the search engine is provided with a results page that includes the advertisement in the sponsored search section. The sponsored search section is prominently displayed in the results page, to enable the user to easily see and interact with the advertisement. In this manner, an advertiser is enabled to provide advertisements to users that are directly related to their queries.

“Context” in sponsored search is additional information such as age, gender or geographical location of a user associated with a query that can change the relevance or value of the query to an advertiser. For example, an advertiser may be interested in promoting a product to a particular gender, to a particular age demographic (e.g., persons in the range of 15-35 years of age), and/or to a particular locality. By taking such context into account when performing sponsored search operations, a search engine can target advertisements even more precisely for advertisers. For example, the age of a user that inputs a query to a search engine may be known. If the age of the user is within an age range of heightened relevance to an advertiser, the advertiser may be willing to provide additional compensation to have the advertisement prominently appear in the search results page for that user.

Context related to users is becoming an important factor in sponsored search. Advertisers may be willing to pay more for advertisements displayed in results pages for desirable combinations of query terms and known context information. Thus, context can potentially be used to generate additional revenue for companies that operate search engines. However, conventional sponsored search systems do not currently price context efficiently. Thus, such systems do not currently generate as much additional revenue as may be possible.

### BRIEF SUMMARY OF THE INVENTION

Sponsored search auction systems are provided that bundle context. A sponsored search auction system is configured to receive bids for queries from advertisers. Each bid is for a particular context relating to a user that may submit the query to a search engine. The bids provide a valuation for each available context of the query for each advertiser. The bids are processed to generate one or more context bundles. The context bundles are groupings of contexts. Not all contexts are necessarily bundled. The bundled and unbundled (if present) contexts may be sold to the advertisers. Selling of contexts in bundled form may enable increased revenue to be generated as compared to auction systems that sell each context separately or sell all contexts bundled into a single group.

In one example, a method for a sponsored search auction is provided. A matrix of valuations is received that includes a valuation for each context of a set of contexts for each agent of a plurality of n agents. At least one context bundle is generated that includes one or more contexts of the set of contexts based on the received matrix of valuations. The at least one context bundle is sold to at least one corresponding agent of the plurality of n agents.

In a further example, a sponsored search auction system is provided. The sponsored search auction includes a context bundler. The context bundler is configured to bundle contexts related to a query. The context bundler is configured to receive a matrix of valuations that includes a valuation for each context of a set of contexts for each agent of a plurality of n agents, and to generate at least one context bundle that includes one or more contexts of the set of contexts based on the received matrix of valuations.

The sponsored search auction system may further include an input interface configured to receive bids for the set of contexts from the agents to form the valuation matrix. Furthermore, the sponsored search auction system may include an output interface configured to enable the agents to pay for the generated context bundles.

In an example, the context bundler may be configured to calculate a first revenue according to:

$$first revenue = {\sum }_{j ∈ {A}_{1}} {s}_{j} + {\sum }_{i = 1}^{n / 2} {w}_{2 i + 1} ;$$

where
i=an agent of the plurality of n agents,
j=a context of the set of contexts in the matrix of valuations,
vᵢⱼ=a valuation of context j by agent i in the matrix of valuations,
hⱼ=a highest valuation for context j in the matrix of valuations,
sⱼ=a second highest valuation for context j in the matrix of valuations,
Aᵢ=a subset of the set of contexts for which an agent i has provided the highest valuation (s), and
wᵢ=a sum of highest context valuations hⱼ provided by agent i;
   The context bundler may be further configured to calculate a second revenue according to:

$$second revenue = {\sum }_{i = 1}^{n / 2} {w}_{2 i} ; and$$

The context bundler may be configured to compare the first revenue to the second revenue to determine one or more context bundles.

In an example, the context bundler may be configured to compare the first revenue to the second revenue. If the first revenue is greater than or equal to (≧) the second revenue, each context of the subset of contexts corresponding to the first agent may remain unbundled, and the subset of contexts corresponding to subsequent pairs of agents (e.g., a first pair that includes agents 2 and 3, a second pair that includes agents 4 and 5, etc.) may be bundled together to form a first set of n/2 context bundles. If the second revenue is greater than the first revenue, the subset of contexts corresponding to each adjacent pair of agents, starting with the first agent (e.g., a first pair that includes agents 1 and 2, a second pair that includes agents 3 and 4, etc.) may be bundled together to form a second set of n/2 context bundles.

Note that in some cases, one or more of the context bundles may be empty.

In an example implementation, the context bundler may include a first valuation determiner, a second valuation determiner, a context subset determiner, a first calculator, an ordering module, a second calculator, a first summer, a second summer, a third summer, and a bundling module. The first valuation determiner is configured to determine a highest valuation in the matrix of valuations for each context of the set of contexts. The second valuation determiner is configured to determine a second highest valuation in the matrix of valuations for each context of the set of contexts. The context subset determiner is configured to determine a subset of contexts of the set of contexts corresponding to each agent. The first calculator is configured to calculate a total valuation of the corresponding subset of contexts for each agent. The ordering module is configured to number the agents from an agent one (first agent) to an agent n in order of decreasing calculated valuation of the corresponding subset of contexts. The second calculator is configured to calculate for the first agent a sum of the determined second highest valuations for the corresponding subset of contexts. The first summer is configured to sum the total valuations determined for odd numbered agents (other than the first agent) to determine a first sum. The second summer is configured to sum the first sum and the sum calculated for the first agent to determine a first revenue. The third summer is configured to sum the total valuations determined for even numbered agents to determine a second revenue. The bundling module is configured to bundle the set of contexts based upon the first revenue and the second revenue.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a document retrieval system.

FIG. 2 shows an example query that may be submitted by a user to a search engine.

FIG. 3 shows search results displayed on a webpage by a search engine in response to an example query.

FIG. 4 shows a block diagram of a sponsored search auction system, according to an example embodiment of the present invention.

FIG. 5 shows a flowchart for performing a query auction, according to an example embodiment of the present invention.

FIG. 6 shows an example matrix of valuations, according to an embodiment of the present invention.

FIG. 7 shows a block diagram of an auction input interface coupled to a network, according to an example embodiment of the present invention.

FIG. 8 shows a flowchart for bundling context, according to an example embodiment of the present invention.

FIG. 9 shows a block diagram of a context bundler, according to an example embodiment of the present invention.

FIGS. 10 and 11 show first and second bundling processes, respectively, that may be performed, according to embodiments of the present invention.

FIG. 12 shows a block diagram of an example computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the present invention enable the bundling of context in sponsored search applications. FIG. 1 shows an example environment in which sponsored search may be implemented. FIG. 1 shows a document retrieval system 100, according to an example embodiment of the present invention. As shown in FIG. 1, system 100 includes a search engine 106. One or more computers 104, such as first-third computers 104a-104c, are connected to a communication network 105. Network 105 may be any type of communication network, such as a local area network (LAN), a wide area network (WAN), or a combination of communication networks. In embodiments, network 105 may include the Internet and/or an intranet. Computers 104 can retrieve documents from entities over network 105. In embodiments where network 105 includes the Internet, a collection of documents, including a document 103, which form a portion of World Wide Web 102, are available for retrieval by computers 104 through network 105. On the Internet, documents may be identified/located by a uniform resource locator (URL), such as http://www.documents.com/documentX, and/or by other mechanisms. Computers 104 can access document 103 through network 105 by supplying a URL corresponding to document 103 to a document server (not shown in FIG. 1).

As shown in FIG. 1, search engine 106 is coupled to network 105. Search engine 106 accesses a stored index 114 that indexes documents, such as documents of World Wide Web 102. A user of computer 104a who desires to retrieve one or more documents relevant to a particular topic, but does not know the identifier/location of such a document, may submit a query 112 to search engine 106 through network 105. Search engine 106 receives query 112, and analyzes index 114 to find documents relevant to query 112. For example, search engine 106 may determine a set of documents indexed by index 114 that include terms of query 112. The set of documents may include any number of documents, including tens, hundreds, thousands, or even millions of documents. Search engine 106 may use a ranking or relevance function to rank documents of the retrieved set of documents in an order of relevance to the user. Documents of the set determined to most likely be relevant may be provided at the top of a list of the returned documents in an attempt to avoid the user having to parse through the entire set of documents.

Search engine 106 may be implemented in hardware, software, firmware, or any combination thereof. For example, search engine 106 may include software/firmware that executes in one or more processors of one or more computer systems, such as one or more servers. Examples of search engine 106 that may be accessible through network 105 include, but are not limited to, Yahoo! Search™ (at http://www.yahoo.com), Ask.com™ (at http://www.ask.com), and Google™ (at http://www.google.com).

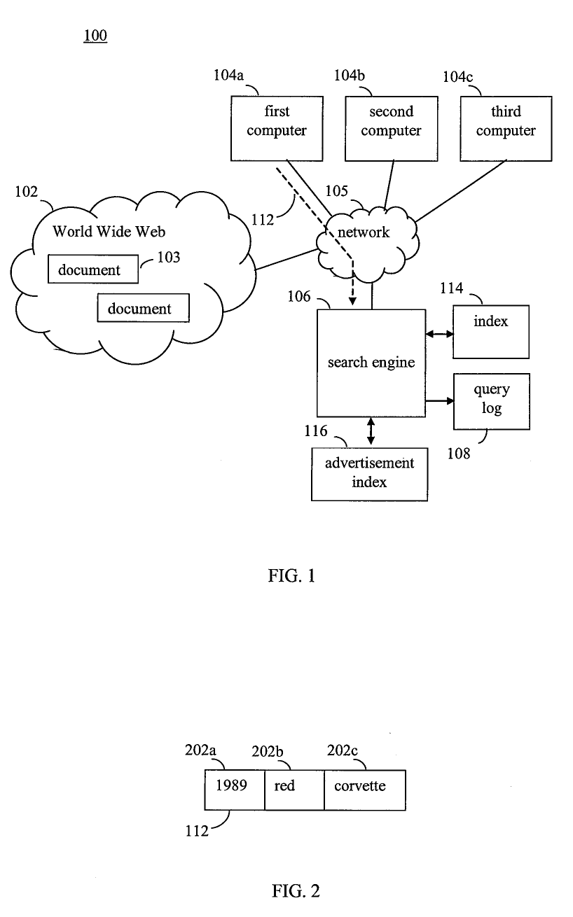

FIG. 2 shows an example query 112 that may be submitted by a user of one of computers 104a-104c of FIG. 1 to search engine 106. Query 112 includes one or more terms 202, such as first, second, and third terms 202a-202c shown in FIG. 2. Any number of terms 202 may be present in a query. As shown in FIG. 2, terms 202a-202c of query 112 are “1989,” “red,” and “corvette.” Search engine 106 applies these terms 202a-202c to index 114 to retrieve a document locator, such as a URL, for one or more indexed documents that match “1989,” “red,” and “corvette,” and may order the list of documents according to a ranking. As shown in FIG. 1, search engine 106 may generate a query log 108. Query log 108 is a record of searches that are made using search engine 106.

“Sponsored search” refers to a form of Internet advertising/marketing that enables advertisers to increase their visibility in the results page of a search engine query. In sponsored search, an advertiser may pay or provide other consideration for having information, such as a link to a website of the advertiser, appear in a sponsored section of the results webpage for one or more particular queries. The sponsored section is prominently displayed in the results page, to enable the user to easily view and interact with the displayed information of the advertiser. In this manner, an advertiser is enabled to provide advertisements to users that are directly related to their queries.

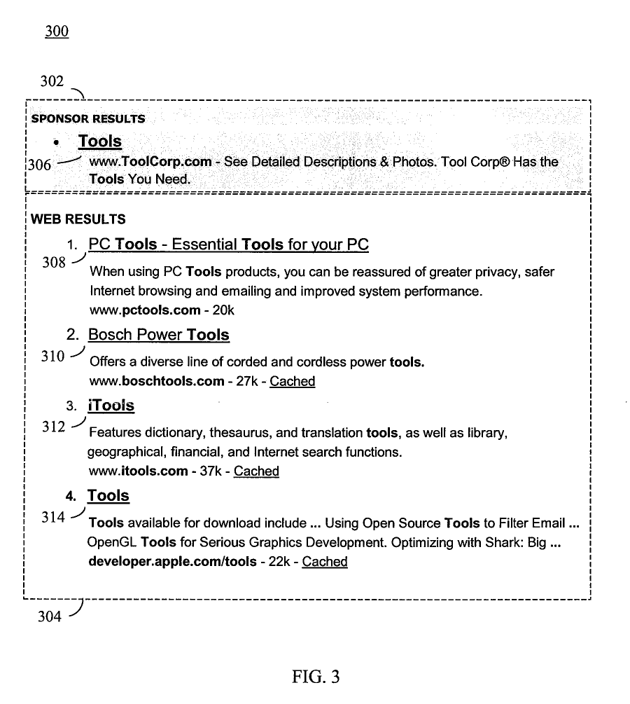

FIG. 3 shows search results, including sponsored search results, displayed on a webpage 300 by search engine 106 in response to a single-term query “tools.” Search engine 106 may analyze the query “tools” to determine whether the query relates to a particular advertiser and/or advertisement, and if so, may display an advertisement of the advertiser in the form of a sponsored link. For example, as shown in FIG. 1, search engine 106 may access an advertisement index 116. Advertisement index 116 may include a mapping of queries to advertisers/advertisements, and may include a ranking of advertisements where more than one advertisement relates to a particular query. When search engine 106 receives a query, search engine 106 may access advertisement index 116 to determine whether advertisers/advertisements are present that correspond to the query, and to select an advertisement from a list if multiple advertisements exist for the query.

In the example of FIG. 3, search engine 106 determined that the query “tools” relates to an advertisement of a company called “Tool Corp,” which in the current example is an advertiser that provides advertisements to search engine 106. In webpage 300, which is generated in response to the “tools” query, search engine 106 displays an advertisement page portion 302 and a search results page portion 304. As shown in FIG. 3, advertisement page portion 302 includes an advertisement 306 in the form of advertisement text and a sponsored link (www.ToolCorp.com) of Tool Corp. Although a single sponsored link is provided in advertisement page portion 302 in the example of FIG. 3, additional sponsored links may additionally be provided. Search results page portion 304 lists search results for the query “tools,” including documents/links 308, 310, 312, and 314 (further resulting document/links are not shown in FIG. 3 for purposes of brevity), in a standard fashion for search engine 106. In this manner, a search engine may display search results for a query, and may match a particular advertiser with computer users who may be interested in a product or service of the advertiser according to the query entered by the user.

“Context” in sponsored search is additional information such as age, gender or geographical location of a user associated with a query that can change the relevance or value of the query to an advertiser. For example, an advertiser may be interested in promoting a product to a particular gender, a particular age demographic (e.g., persons in the range of 15-35 years of age), and/or a particular locality. By taking such context into account when performing sponsored search operations, a search engine can target advertisements even more precisely for advertisers.

For instance, the query term “tools” may have heightened relevance to the advertiser when combined with particular context information. For example, users in the age range of 20-40 that input the query term “tools” may have heightened relevance to the advertiser. Thus, the advertiser may be willing to provide additional compensation (e.g., to a controlling/operating entity of search engine 106) to have an advertisement appear in the search results page for the query term “tools” for users in the age range of 20-40.

In many cases, an auction is used to sell sponsored search advertisements. An auction system may be used to enable advertisers to bid to provide advertising for particular combinations of queries and context. A separate auction is run for each query. Context may be taken into account in such auctions. Two types of such auction systems that take context into account include a “pure bundled auction” (also referred to as a completely bundled auction) and a “completely unbundled auction.” In a completely bundled auction, all context for a query may be bid for in a single auction (e.g., similar to a case where context is not taken into account). For example, an auction may be performed for a combination of the query term “tool” over all age ranges. In a completely unbundled auction, each context for a query may be bid for in a separate auction. Thus, multiple auctions are performed in a completely unbundled auction, one for each context. For example, a first auction may be performed for a combination of the query term “tool” and the age range of 21-30, and a second auction may be performed for a combination of the query term “tool” and the age range of 31-40.

Completely bundled auctions and completely unbundled auctions have disadvantages. In general, advertiser welfare is maximized if a separate auction is performed for each context. However, due to a potential for lack of competition within each context, a significant loss in revenue to the search engine (e.g., to an owner, operator, and/or controlling entity of search engine 106) may occur. Neither completely bundled nor completely unbundled auctions are configured to maximize revenue for the auctioning entity. Thus, a search engine may not reach its earning potential by using completely bundled auctions and completely unbundled auctions.

Embodiments of the present invention provide for an intermediate form of context bundling in auctions that enable improved revenue for auctioning entities when compared to completely bundled and completely unbundled auctions. Example embodiments of the present invention are described in detail in the following section.

### Example Bundled Context Embodiments

Example embodiments are described for bundling context with respect to a query auction. The example embodiments described herein are provided for illustrative purposes, and are not limiting. Further structural and operational embodiments, including modifications/alterations, will become apparent to persons skilled in the relevant art(s) from the teachings herein.

Any suitable type of context relevant to a query may be bundled in embodiments of the present invention. Example types of context include age (e.g., numerical age; categorical age such as senior, adult, teen, or child; etc.), gender (e.g., male or female), geographical location (e.g., country, state, city, zip code, IP address, etc.), hobbies or interests, education level (e.g., none, elementary school, high school, college, advanced degree, etc.), type of employment, and/or further types of context.

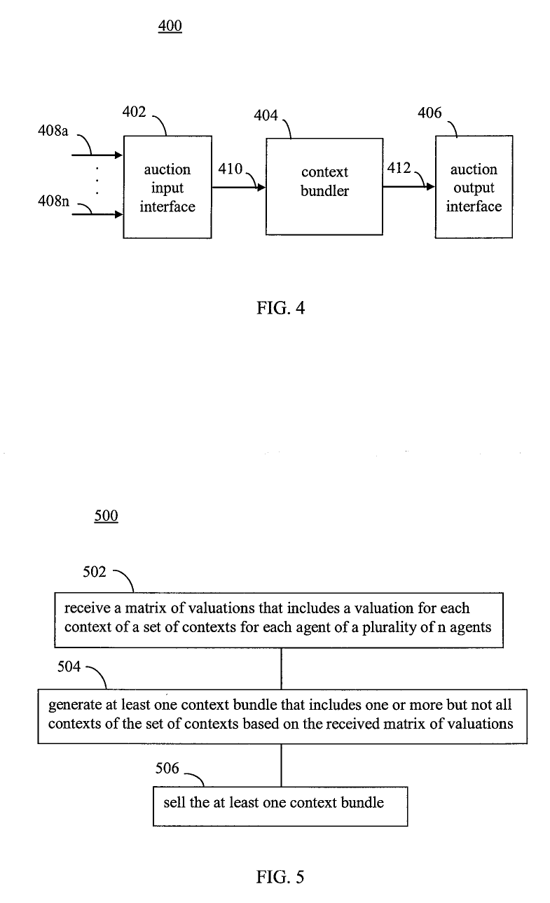

FIG. 4 shows a sponsored search auction system 400, according to an example embodiment of the present invention. As shown in FIG. 4, sponsored search auction system 400 includes an auction input interface 402, a context bundler 404, and an auction output interface 406. Sponsored search auction system 400 is configured to receive bids for queries from advertisers. Each bid on a particular query relates to a particular context. A valuation (bid amount) is provided for each available context of the query. Sponsored search auction system 400 processes the bids to generate one or more context bundles. The context bundles are groupings of contexts, although not necessarily all contexts are bundled (some may remain separate or “unbundled”). Sponsored search auction system 400 outputs the one or more context bundles (and optionally one or more unbundled contexts), which are provided to the bidding advertisers for compensation. The bundling of contexts by sponsored search auction system 400 enables increased revenue to be generated as compared to completely bundled and completely unbundled auction systems.

Sponsored search auction system 400 may be implemented in hardware, software, firmware, or any combination thereof. For example, sponsored search auction system 400 may be hosted in one or more computer systems that each include one or more processors and/or logic configured to enable the functionality of auction system 400.

Sponsored search auction system 400 may operate in a variety of ways. For example, FIG. 5 shows a flowchart 500 for performing a query auction, according to an example embodiment of the present invention. Flowchart 500 may be performed by sponsored search auction system 400. Further structural and operational embodiments will be apparent to persons skilled in the relevant art(s) based on the discussion regarding flowchart 500. Flowchart 500 is described as follows.

Flowchart 500 begins with step 502. In step 502, a matrix of valuations is received that includes a valuation for each context of a set of contexts for each agent of a plurality of n agents. In an embodiment, as shown in FIG. 4, a matrix of valuations 410 may be received by context bundler 404. Matrix of valuations 410 is a matrix that includes valuations for various contexts provided by agents (e.g., advertisers or other entities) participating in an auction. Each agent provides a valuation for each context of interest.

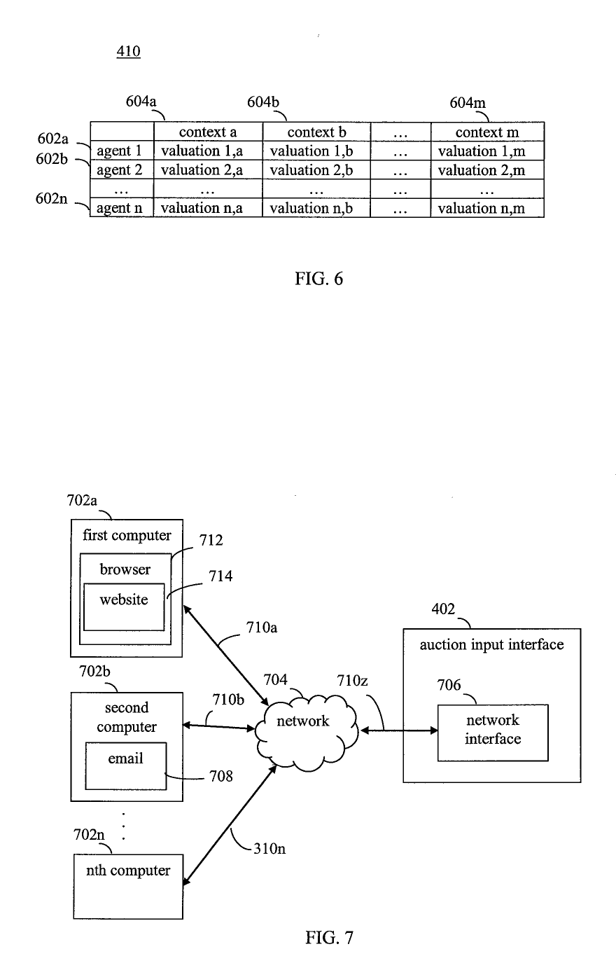

FIG. 6 shows an example matrix of valuations 410, according to an embodiment of the present invention. As shown in FIG. 6, matrix of valuation 410 has the form of a table that includes n rows 602a-602n representing n agents and m columns 604a-604m representing a set of m contexts. Matrix of valuation 410 may have any number of rows (agents) and columns (contexts). At the intersection of each row 602 and column 604 is a valuation for the corresponding context provided by the corresponding agent. For example, at the intersection of row 602b and column 604b, agent 2 has provided a valuation 2,b for context b. Note that for illustrative purposes, matrix of valuations 410 is shown in FIG. 6 in table form. In embodiments, matrix of valuations 410 may have any form suitable for listing valuations of contexts for agents.

The valuations in matrix of valuations 410 may be represented in any suitable manner, including as monetary amounts (e.g., in dollars or other currency.). A valuation may be selected by an agent in any manner. For example, in an embodiment, a valuation may be a calculated quantity. For example, a valuation for a context may be determined as a click through rate (CTR) multiplied by a value-per-click, which may be a historical CTR (e.g., determinable from query log 108 shown in FIG. 1) or an estimated future CTR. A value-per-click may be an amount determined in any manner, including being determined by the search engine operating entity or by the agent submitting the valuation.

As shown in FIG. 4, matrix of valuations 410 may be received by context bundler 404 from auction input interface 402. Auction input interface 402 may be any sort of interface, or a collection of interfaces, that enables matrix of valuations 410 to be generated. For example, auction input interface 402 may include an input device (e.g., a keyboard of a computer), a display device, and/or any other suitable user interface mechanism. As shown in FIG. 4, auction input interface 402 receives a plurality of bids 408a-408n from n agents. Bids 408a-408n include valuations for contexts of interest from the respective agents. Auction input interface 402 generates matrix of valuations 410 from bids 408a-408n.

In an embodiment, auction input interface 402 may be configured to enable agents to provide valuations to auction system 400 from one or more remote computer systems. For instance, FIG. 7 shows a block diagram of auction input interface 402 coupled to first-nth computers 702a-702n through a network 704, according to an example embodiment of the present invention. As shown in FIG. 7, auction input interface 402 may include a network interface 706. Any number of computers 702 may be present in system 300. Computers 702 can be any type of computer, including server, desktop, or mobile. In the embodiment of FIG. 7, agents use computers 702a-702n to provide valuations to auction input interface 402. Computers 702a-702n are communicatively coupled to auction input interface 402 through communication links 710a-710n, network 704, and communication link 710z. Communication links 710a-710n couple corresponding ones of computers 702a-702n to network 704, and network interface 706 of auction input interface 402 is coupled to network 704 through communication link 710z.

Computers 702a-702n may enable agents to input bids 408 over communication links 710a-710n in a variety of ways. For example, an agent using first computer 702a may use a browser 712 to access a website 714 hosted by auction input interface 402. Website 714 may have a form or other input mechanism that the agent using first computer 702a can use to input a bid 408. In an embodiment, website 714 is a web service that provides an interface for accessing sponsored search auction system 400 of FIG. 4. In another example, an agent at second computer 702b may generate an email 716, and may transmit email 716 through network 704 to auction input interface 402 to input a bid 408. Further ways of enabling agents to input bids 408 may be enabled by auction input interface 402 in embodiments.

Network 704 may be any type of communication network, such as a local area network (LAN) or wide area network (WAN), or a combination of networks, such as the Internet. Communication links 710 may be any type or combination of communication links suitable for coupling devices to a network, including wired and/or wireless links, such as IEEE 802.11 wireless LAN (WLAN) wireless links, Ethernet links, USB links, etc. Network interface 706 may include any type of network interface, including a wired or wireless interface, such as an as IEEE 802.11 wireless LAN (WLAN) wireless interface, an Ethernet interface, a USB interface, etc.

In step 504, at least one context bundle is generated that includes one or more contexts of the set of contexts based on the received matrix of valuations. In an embodiment, step 504 may be performed by context bundler 404 shown in FIG. 4. Context bundler 404 receives matrix of valuations 410 from auction input interface 402. For a particular auction, context bundler 404 processes matrix of valuations 410 to generate one or more context bundles. Each include context bundle includes one or more contexts. The generated context bundles are output from context bundler 404 as a context bundle signal 412, which indicates the generated context bundles. One or more contexts may be left unbundled that may also be output in context bundle signal 412.

Bundling of contexts by context bundler 404 for an auction enables revenue to be increased (including maximizing revenue in some cases), as compared to auctions that completely bundle all contexts or leave all contexts completely unbundled. In an embodiment, bundling of context by context bundler 404 may achieve a half or more of the maximum revenue that may be achieved by an optimal bundling of contexts. Furthermore, in an embodiment, bundling of context by context bundler 404 may achieve a half or more of the maximum efficiency that may be achieved by an optimal bundling of contexts.

Context bundler 404 may be implemented in hardware, software, firmware, or any combination thereof. For instance, in an embodiment, context bundler 404 may be implemented in computer code that executes in one or more processors. In another embodiment, context bundler 404 may be implemented as logic in one or more electrical circuits, such as an application specific integrated circuit (ASIC). Further example embodiments for context bundler 404 are described in detail further below.

In step 506, the at least one context bundle is sold. As shown in FIG. 4, auction output interface 406 may receive context bundle signal 412. Auction output interface 406 may be configured to enable the one or more bundled contexts and any unbundled contexts indicated in context bundle signal 412 to be provided to the corresponding agents for a corresponding revenue amount. For example, auction output interface 406 may calculate a valuation for each context bundle in context bundle signal 412. Auction output interface 406 may determine context valuations in any manner, including according to a “first price auction,” a “second price auction,” or other valuation method. For a first price auction, a highest bidder is listed first in the sponsored search section of the results page, and pays (e.g., per click) the highest bid amount. For a second price auction, the highest bidder is listed first in the sponsored search section of the results page, and pays the second highest bid amount (the second highest bidder is listed second and pays the third highest bid amount, etc.). For a first price auction, auction output interface 406 may calculate a context bundle valuation by summing the highest valuations provided in matrix of valuations 410 for each context in the bundle. For a second price auction, auction output interface 406 may calculate a context bundle valuation by summing the second highest valuations provided in matrix of valuations 410 for each context in the bundle.

Auction output interface 406 may include any sort of interface, or a collection of interfaces, that enables the bundled (and any unbundled) contexts to be provided. For example, auction output interface 406 may include an output device, such as a printer, a display device, and/or any other suitable user interface mechanism to provide the bundled contexts and any unbundled contexts to the corresponding agents. Furthermore, auction output interface 406 may provide an interface that enables the agents to pay for the provided bundled contexts and any unbundled contexts. In an embodiment, auction output interface 406 may include a network interface (e.g., network interface 706 shown in FIG. 7) to enable the communication of the determined bundled/unbundled contexts to agents at remote computer systems, and to enable the agents to pay accordingly. For example, a website and/or email may be used to communicate with the agents at computers 702a-702n in a similar manner as described above with respect to auction input interface 402.

Context bundler 404 shown in FIG. 4 may be configured to determine context bundles in a variety of ways. An example embodiment for context bundler 404 is described as follows. The following embodiment uses a second price auction valuation technique, for purposes of illustration. However, the following embodiment may be adapted to a first price auction valuation technique, or to another valuation technique, as would be known to persons skilled in the relevant arts.

In an embodiment, context bundler 404 may be configured to perform Equations 1 and 2 shown below to generate first and second revenues. The first and second revenues may be used to determine one or more bundles of contexts:

$$\begin{matrix}Revenue 1 = {\sum }_{j ∈ {A}_{1}} {s}_{j} + {\sum }_{i = 1}^{n / 2} {w}_{2 i + 1} & Equation 1 \\ Revenue 2 = {\sum }_{i = 1}^{n / 2} {w}_{2 i} & Equation 2\end{matrix}$$

where

i=an agent of the plurality of n agents,

j=a context of the set of contexts in the matrix of valuations,

vᵢⱼ=a valuation of context j by agent i in the matrix of valuations,

hⱼ=a highest valuation for context j in the matrix of valuations,

sⱼ=a second highest valuation for context j in the matrix of valuations,

Aᵢ=a subset of the set of contexts for which an agent i has provided the highest valuation (s), and

wᵢ=a sum of highest context valuations hⱼ provided by agent

$$i ( i . e . , {\sum }_{j ∈ {A}_{i}} {h}_{j} ) ,$$

Note that the agents are numbered from an agent one (first agent) to an agent n in order of decreasing calculated valuation of the corresponding subset of contexts (i.e., numbered so that w₁≧w₂≧w₃≧ . . . ≧wₙ).

To determine context bundles, in an embodiment, context bundler 404 may be configured to compare Revenue 1 to Revenue 2. In a first case, if Revenue 1 is greater than or equal to Revenue 2, context bundler 404 may be configured to provide one or more separate contexts and one or more bundled contexts in context bundle signal 412. In a second case, if Revenue 2 is greater than Revenue 1, context bundler 404 may be configured to provide one or more bundled contexts in context bundle signal 412. Context bundler 404 may bundle contexts in various ways based on Revenue 1 and Revenue 2. Examples of such bundling are described further below.

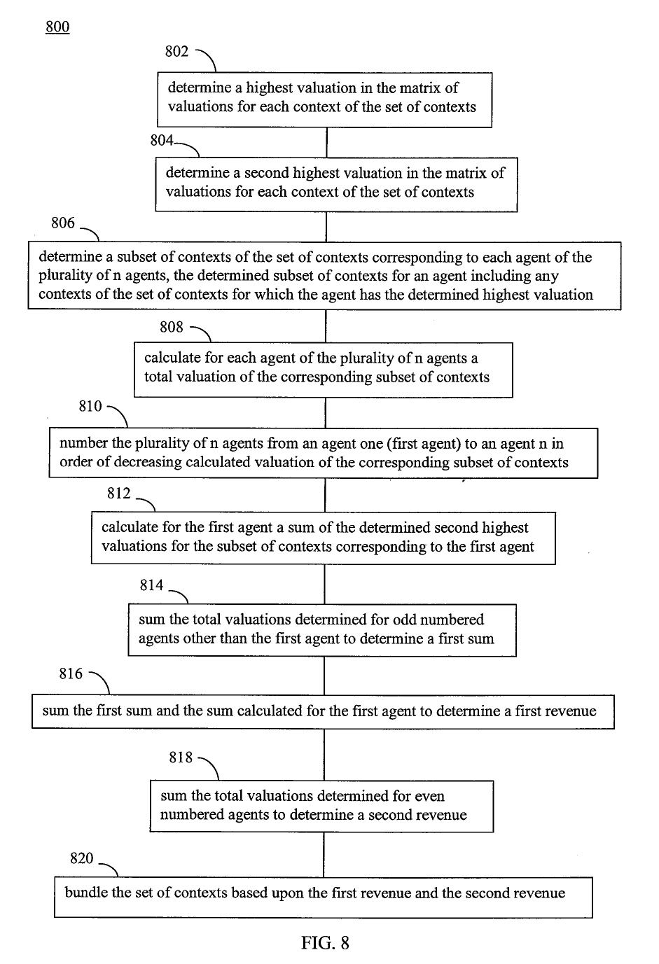

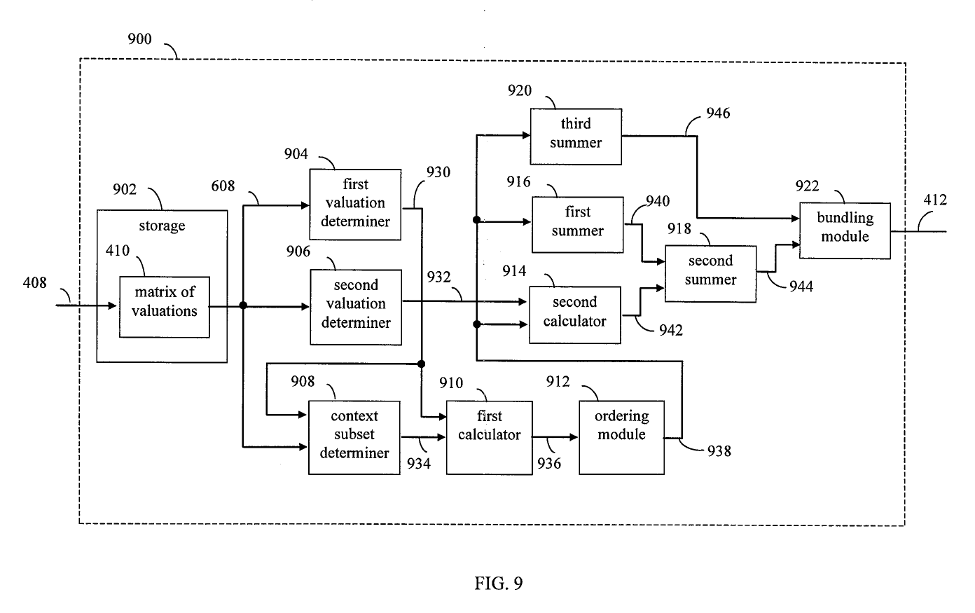

Context bundler 404 may be configured in various ways to determine context bundles according to Equations 1 and 2. FIG. 8 shows a flowchart 800 for determining context bundles, according to an example embodiment of the present invention. Flowchart 800 may be performed by a context bundler 900 shown in FIG. 9, which is an example of context bundler 404 shown in FIG. 4. Context bundler 900 is configured to determine context bundles according to Equations 1 and 2. As shown in FIG. 9, context bundler 900 includes a storage 902, a first valuation determiner 904, a second valuation determiner 906, a context subset determiner 908, a first calculator 910, an ordering module 912, a second calculator 914, a first summer 916, second summer 918, a third summer 920, and a bundling summer 922. For illustrative purposes, flowchart 800 is described below with respect to context bundler 900. The steps of flowchart 800 can be performed in orders other than shown in FIG. 8. Further structural and operational embodiments will be apparent to persons skilled in the relevant art(s) based on the discussion regarding flowchart 800. Flowchart 800 is described as follows.

Flowchart 800 begins with step 802. In step 802, a highest valuation in the matrix of valuations for each context of the set of contexts is determined. As shown in FIG. 9, matrix of valuations 410 may be received and stored in storage 902. Storage 902 is optionally present, and may be any type of physical or virtual storage mechanism. As shown in FIG. 9, first valuation determiner 904 receives matrix of valuations 410 from storage 902. First valuation determiner 904 determines the highest valuation present in matrix of valuations 410 for each context, and generates a highest valuation indication signal 930.

For instance, Table 1 below shows an example of matrix of valuations 410 for a query “bicycle”:

TABLE 1

| | | | | age | | age |
|---|---|---|---|---|---|---|
| | age 0-12 | age 13-19 | age 20-39 | 40-59 | age 60-69 | 70-100 |
| agent 1 | 1.0 | 2.0 | 0 | 1.0 | 0.5 | 2.5 |
| agent 2 | 0 | 1.0 | 2.0 | 0 | 0 | 1.5 |
| agent 3 | 0.5 | 0 | 0.5 | 2.5 | 1.5 | 0.5 |

In the example of Table 1, three agents are included, and the set of contexts includes six age ranges of 0-12, 13-19, 20-39, 40-59, 60-69, and 70-100. As indicated in Table 1, agent 1 values ages 0-12 a medium amount (valuation of 1.0), ages 13-19 a high amount (valuation of 2.0), age 20-39 the least (valuation of 0), age 40-59 a medium amount (valuation of 1.0), ages 60-69 a low amount (valuation of 0.5), and ages 70-100 the highest (valuation of 2.5). Agents 2 and 3 have similarly provided valuations for all six age ranges.

First valuation determiner 904 may be configured to determine the highest valuation present for each context in any manner, including by comparing the listed valuations on a context (column) basis. With regard to the example matrix of valuations 410 shown in Table 1, first valuation determiner 904 may generate highest valuation indication signal 930 to include the highest valuation information included in Table 2 below:

TABLE 2

| age 0-12 | age 13-19 | age 20-39 | age 40-59 | age 60-69 | age 70-100 |
|---|---|---|---|---|---|
| 1.0 | 2.0 | 2.0 | 2.5 | 1.5 | 2.5 |

In step 804, a second highest valuation in the matrix of valuations for each context of the set of contexts is determined. As shown in FIG. 9, second valuation determiner 906 receives matrix of valuations 410 from storage 902. Second valuation determiner 906 determines the second highest valuation present in matrix of valuations 410 for each context, and generates a second highest valuation indication signal 932. Second valuation determiner 906 may be configured to determine the highest valuation present for each context in any manner, including by comparing the listed valuations on a context (column) basis, to determine the second highest valuation for each context. With regard to the example matrix of valuations 410 shown in Table 1, second valuation determiner 906 may generate second highest valuation indication signal 932 to include the second highest valuation information included in Table 3 below:

TABLE 3

| age 0-12 | age 13-19 | age 20-39 | age 40-59 | age 60-69 | age 70-100 |
|---|---|---|---|---|---|
| 0.5 | 1.0 | 0.5 | 1.0 | 0.5 | 1.5 |

In step 806, a subset of contexts of the set of contexts corresponding to each agent of the plurality of n agents is determined, the determined subset of contexts for an agent including any contexts of the set of contexts for which the agent has the determined highest valuation. As shown in FIG. 9, context subset determiner 908 receives matrix of valuations 410 and receives highest valuation indication signal 930. Context subset determiner 908 determines a subset of the set of contexts in matrix of valuations 410 for each agent, such that the subset for each agent includes the context for which an agent has the highest valuation, and generates a context subset signal 934. Context subset determiner 908 may be configured to determine the subsets in any manner, including by matching the highest valuations provided in highest valuation indication signal 930 with the agent-by-agent valuations provided in matrix of valuations 410.

With regard to the example matrix of valuations 410 shown in Table 1, and the example highest valuation information in Table 2, context subset determiner 908 may generate context subset signal 934 to include the context subset information included in Table 4 below, where each row corresponds to a context subset for an agent:

TABLE 4

| | | | | age | | age |
|---|---|---|---|---|---|---|
| | age 0-12 | age 13-19 | age 20-39 | 40-59 | age 60-69 | 70-100 |
| agent 1 | 1.0 | 2.0 | | | | 2.5 |
| agent 2 | | | 2.0 | | | |
| agent 3 | | | | 2.5 | 1.5 | |

In step 808, a total valuation of the corresponding subset of contexts is calculated for each agent of the plurality of n agents. As shown in FIG. 9, first calculator 910 receives context subset signal 934. First calculator 910 determines a total valuation of each subset of context calculated in step 810, to generate a subset total valuation signal 936. Calculator 910 may be configured to determine the total valuations in any manner, including by summing the valuations in each subset provided in context subset information signal 934.

With regard to the example of context subset signal 934 shown in Table 4, first calculator 910 may generate subset total valuation signal 936 to include the subset valuation information included in Table 4 below:

TABLE 5

| | total valuation |
|---|---|
| agent 1 | 5.5 |
| agent 2 | 2.0 |
| agent 3 | 4.0 |

In step 810, the plurality of n agents is numbered from an agent one (first agent) to an agent n in order of decreasing calculated valuation of the corresponding subset of contexts. As shown in FIG. 9, ordering module 912 receives subset total valuation signal 936. Ordering module 912 numbers the agents from one to n in order of decreasing subset valuations to generate an ordered subset total valuation signal 938. Ordering 602 module 912 may be configured to determine the order in any manner, including according to standard ordering/sorting algorithms, as would be known to persons skilled in the relevant art(s).

With regard to the example of subset total valuation signal 936 shown in Table 5, ordering module 912 may generate ordered subset total valuation information signal 938 by renumbering agent 2 as agent 3, and renumbering agent 3 as agent 2, to reorder the total valuations listed in Table 5 in order of decreasing calculated valuation. Table 6 below shows the reordered version of the agents listed in Table 5 to represent an example of ordered subset total valuation signal 938.

TABLE 6

| | total valuation |
|---|---|
| agent 1 | 5.5 |
| agent 2 (formerly agent 3) | 4.0 |
| agent 3 (formerly agent 2) | 2.0 |

In step 812, a sum of the determined second highest valuations for the subset of contexts corresponding to the first agent is calculated. As shown in FIG. 9, second calculator 914 receives second highest valuation indication signal 932 and ordered subset total valuation signal 938. Second calculator 914 determines from ordered subset total valuation signal 938 which agent is the first agent. Second calculator 914 determines a sum of the second highest valuations for the subset of contests of the first agent in second highest valuation indication signal 932, and generates a first agent second highest valuation sum 942.

With regard to the example of ordered subset total valuation information signal 938 described above, agent 1 indicated in Table 6 is the same as agent 1 in Table 3. Table 3 includes two second highest valuations for agent 1-1.0 for ages 40-49 and 0.5 for ages 50-59. Thus, second calculator 914 may generate first agent second highest valuation sum 942 to be 1.5 (1.0+0.5) in the current example.

In step 814, the total valuations determined for odd numbered agents other than the first agent are summed to determine a first sum. As shown in FIG. 9, first summer 916 receives ordered subset total valuation signal 938. First summer 916 determines a sum of the total valuations for the odd numbered agents (except for the first agent) in ordered subset total valuation signal 938, and generates a first sum 940.

In the current example, the only odd agent (other than agent 1) is agent 3. For the example of ordered subset total valuation signal 938 shown in Table 6, agent 3 has a total valuation of 2.0. Thus, first summer 916 may generate first sum 940 to be 2.0 in the current example.

In step 816, the first sum and the sum calculated for the first agent are summed to determine a first revenue. As shown in FIG. 9, second summer 918 receives first sum 940 and first agent second highest valuation sum 942. Second summer 918 sums first sum 940 and first agent second highest valuation sum 942, and generates a first revenue 944.

In the current example, first sum 940 (for agent 3) is 2.0, and first agent second highest valuation sum 942 (for agent 1) is 1.5. Thus, second summer 918 may generate first revenue 944 to be 3.5 (2.0+1.5) in the current example.

In step 818, the total valuations determined for even numbered agents are summed to determine a second revenue. As shown in FIG. 9, third summer 920 receives ordered subset total valuation signal 938. Third summer 920 determines a sum of the total valuations for the even numbered agents in ordered subset total valuation signal 938, and generates a second revenue 946.

In the current example, the only even agent is agent 2. For the example of ordered subset total valuation signal 938 shown in Table 6, agent 2 has a total valuation of 4.0. Thus, third summer 920 may generate second revenue 946 to be 4.0 in the current example.

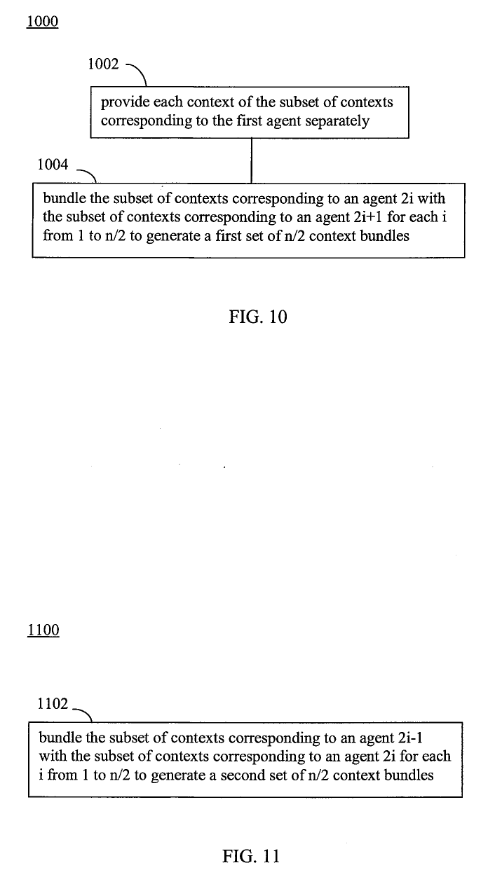

In step 820, the set of contexts is bundled based upon the first revenue and the second revenue. As shown in FIG. 9, bundling module 922 receives first revenue 944 and second revenue 946. Bundling module 922 generates one or more bundled contexts based on first revenue 944 and second revenue 946. For example, one of first and second bundling processes 1000 and 1100, shown in FIGS. 10 and 11 respectively, may be performed in step 820 to generate context bundles, according to embodiments of the present invention.

Bundling module 922 may perform a comparison of first revenue 944 and second revenue 946 to determine a bundling configuration for the set of contexts. In an embodiment, if bundling module 922 determines that first revenue 944 is greater than or equal to (≧) second revenue 946, process 1000 of FIG. 10 may be performed. If second revenue 946 is greater than first revenue 944, process 1100 of FIG. 11 may be performed. Processes 1000 and 1100 are described as follows.

Process 1000 shown in FIG. 10 includes steps 1002 and 1004, which may be performed in either order. In step 1002, each context of the subset of contexts corresponding to the first agent is separately provided. In other words, each context of the subset of contexts corresponding to the agent 1 (first agent) is provided separately (is not bundled). In step 1004 of process 1000, the subset of contexts corresponding to an agent 2i is bundled with the subset of contexts corresponding to an agent 2i+1 for each i from 1 to n/2 to generate a first set of n/2 context bundles. In other words, the subsets of contexts of each subsequent sequential pair of agents (e.g., a first pair of agents 2 and 3, a second pair of agents 4 and 5, etc.) are bundled to generate a first set of n/2 context bundles. Thus, if Revenue 1 is greater than or equal to Revenue 2, the context(s) of agent 1 may be sold separately, and the generated n/2 context bundles of the first set may be sold separately. Note that in some cases, one or more of the generated context bundles of the first set may be empty.

Process 1100 of FIG. 11 (which may be performed if second revenue 946 is greater than first revenue 944) includes a step 1102. In step 1102, the subset of contexts corresponding to an agent 2i−1 is bundled with the subset of contexts corresponding to an agent 2i for each i from 1 to n/2 to generate a second set of n/2 context bundles. In other words, the subsets of contexts of pairs of sequential agents starting with agent 1 (e.g., a first pair of agents 1 and 2, a second pair of agents 3 and 4, etc.) are bundled to generate a second set of n/2 context bundles. Thus, if Revenue 2 is greater than Revenue 1, the generated n/2 context bundles of the second set may be sold separately. Note that in some cases, one or more of the context bundles of the second set may be empty.

Continuing the current example, Revenue 1 (3.5) is compared to Revenue 2 (4.0). In this example, Revenue 2 is greater than Revenue 1. Thus, in the current example, process 1100 of FIG. 11 may be performed. In the current example, n=3 agents. Thus, according to Process 1100, the subset of contexts of agent 1 is bundled with the subset of contexts of agent 2 to form a first bundle. The subset of contexts of agent 3 would be bundled with the subset of contexts of agent 4, except that no agent 4 exists (i.e., the subset of context for agent 4 is an empty set). Thus, the subset of contexts of agent 3 are bundled to form a second bundle.

Referring to Table 4 above, agent 1 has a context subset of age ranges 0-12, 13-19, and 70-100. Agent 2 has a context subset of age ranges 20-39. Agent 3 has a context subset of age ranges 40-59 and 60-69. Thus, the generated first context bundle (agents 1 and 2) includes age ranges 0-12, 13-19, 20-39, and 70-100, and the generated second bundle (agent 3) includes age ranges 40-59 and 60-69. These first and second context bundles are output by context bundler 900 in FIG. 9 in context bundle signal 412. Auction output interface 406 may receive the first and second context bundles, and provide them for sale to agents 1-3.

For the current example, in a second price auction, it is noted that the revenue derived from selling the contexts to agents 1-3 in a completely unbundled manner is 5.5 (the sum of the valuations shown in Table 3). The revenue derived from selling the contexts to agents 1-3 in a completely bundled manner is 5.5, because the completely bundled valuations provided by agents 1-3 (shown in Table 1) are 7.0, 4.5, and 5.5, respectively, and 5.5 is the second highest valuation. In contrast, in the current example embodiment, first and second context bundles are created. The context bundles have the following valuations shown in Table 7 (calculated from the valuations shown in Table 1):

TABLE 7

| | first bundle | second bundle |
|---|---|---|
| agent 1 | 5.5 | 1.5 |
| agent 2 (formerly agent 3) | 1.5 | 4.0 |
| agent 3 (formerly agent 2) | 4.5 | 0 |

As indicated in Table 7, in a second price auction, auction output interface 406 may sell the first and second context bundles for 4.5 and 1.5, respectively, for a total revenue of 6.0. The total revenue of 6.0 in the current example embodiment is greater than the revenues of 5.5 and 5.5 available in the completely bundled and completely unbundled 602 auction techniques. Thus, in the current example embodiment, additional revenue may be collected by generating bundled contexts (the first and second context bundles), rather complete bundling or complete unbundling of contexts.

Note that storage 902, first valuation determiner 904, second valuation determiner 906, context subset determiner 908, first calculator 910, ordering module 912, second calculator 914, first summer 916, second summer 918, third summer 920, and bundling summer 922 shown in FIG. 9 may be implemented in hardware, software, firmware, or any combination thereof.

### Example Computer Implementation

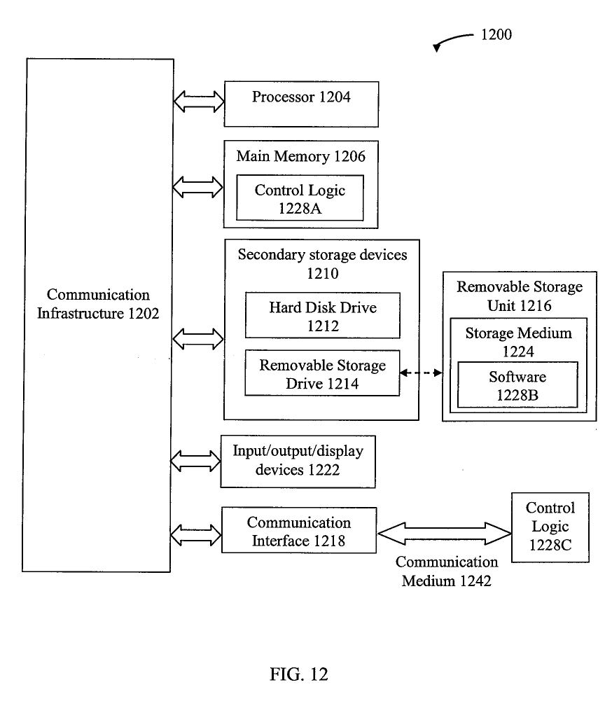

The embodiments described herein, including systems, methods/processes, and/or apparatuses, may be implemented using well known servers/computers, such as computer 1200 shown in FIG. 12. For example, sponsored search auction system 400 of FIG. 4, query bundler 900 of FIG. 9, flowchart 500 shown in FIG. 5, flowchart 800 shown in FIG. 8, process 1000 shown in FIG. 10, and process 1100 shown in FIG. 11, can be implemented using one or more computers 1200.

Computer 1200 can be any commercially available and well known computer capable of performing the functions described herein, such as computers available from International Business Machines, Apple, Sun, HP, Dell, Cray, etc. Computer 1200 may be any type of computer, including a desktop computer, a server, etc.

Computer 1200 includes one or more processors (also called central processing units, or CPUs), such as a processor 1204. Processor 1204 is connected to a communication infrastructure 1202, such as a communication bus. In some embodiments, processor 1204 can simultaneously operate multiple computing threads.

Computer 1200 also includes a primary or main memory 1206, such as random access memory (RAM). Main memory 1206 has stored therein control logic 1228A (computer software), and data.

Computer 1200 also includes one or more secondary storage devices 1210. Secondary storage devices 1210 include, for example, a hard disk drive 1212 and/or a removable storage device or drive 1214, as well as other types of storage devices, such as memory cards and memory sticks. For instance, computer 1200 may include an industry standard interface, such a universal serial bus (USB) interface for interfacing with devices such as a memory stick. Removable storage drive 1214 represents a floppy disk drive, a magnetic tape drive, a compact disk drive, an optical storage device, tape backup, etc.

Removable storage drive 1214 interacts with a removable storage unit 1216. Removable storage unit 1216 includes a computer useable or readable storage medium 1224 having stored therein computer software 1228B (control logic) and/or data. Removable storage unit 1216 represents a floppy disk, magnetic tape, compact disk, DVD, optical storage disk, or any other computer data storage device. Removable storage drive 1214 reads from and/or writes to removable storage unit 1216 in a well known manner.

Computer 1200 also includes input/output/display devices 1222, such as monitors, keyboards, pointing devices, etc.

Computer 1200 further includes a communication or network interface 1218. Communication interface 1218 enables the computer 1200 to communicate with remote devices. For example, communication interface 1218 allows computer 1200 to communicate over communication networks or mediums 1242 (representing a form of a computer useable or readable medium), such as LANs, WANs, the Internet, etc. Network interface 1218 may interface with remote sites or networks via wired or wireless connections.

Control logic 1228C may be transmitted to and from computer 1200 via the communication medium 1242.

Any apparatus or manufacture comprising a computer useable or readable medium having control logic (software) stored therein is referred to herein as a computer program product or program storage device. This includes, but is not limited to, computer 1200, main memory 1206, secondary storage devices 1210, and removable storage unit 1216. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for a sponsored search auction, comprising:
receiving a matrix of valuations that includes a valuation for each context of a set of contexts for each agent of a plurality of n agents;
generating at least one context bundle that includes one or more contexts of the set of contexts based on the received matrix of valuations; and
selling the at least one context bundle to at least one corresponding agent of the plurality of n agents.

2. The method of claim 1, wherein said generating at least one context bundle comprises:
calculating a first revenue according to:
$$first revenue = {\sum }_{j ∈ {A}_{1}} {s}_{j} + {\sum }_{i = 1}^{n / 2} {w}_{2 i + 1} ;$$
where
i=an agent of the plurality of n agents,
j=a context of the set of contexts in the matrix of valuations,
vᵢⱼ=a valuation of context j by agent i in the matrix of valuations,
hⱼ=a highest valuation for context j in the matrix of valuations,
sⱼ=a second highest valuation for context j in the matrix of valuations,
Aᵢ=a subset of the set of contexts for which an agent i has provided the highest valuation (s), and
wᵢ=a sum of highest context valuations hⱼ provided by agent i;
calculating a second revenue according to:
$$second revenue = {\sum }_{i = 1}^{n / 2} {w}_{2 i} ; and$$
comparing the first revenue to the second revenue.

3. The method of claim 1, wherein said generating at least one context bundle comprises:
determining a highest valuation in the matrix of valuations for each context of the set of contexts;
determining a second highest valuation in the matrix of valuations for each context of the set of contexts;
determining a subset of contexts of the set of contexts corresponding to each agent of the plurality of n agents, the determined subset of contexts for an agent including any contexts of the set of contexts for which the agent has the determined highest valuation;
calculating for each agent of the plurality of n agents a total valuation of the corresponding subset of contexts;
numbering the plurality of n agents from an agent one (first agent) to an agent n in order of decreasing calculated valuation of the corresponding subset of contexts;
calculating for the first agent a sum of the determined second highest valuations for the subset of contexts corresponding to the first agent;
summing the total valuations determined for odd numbered agents other than the first agent to determine a first sum;
summing the first sum and the sum calculated for the first agent to determine a first revenue;
summing the total valuations determined for even numbered agents to determine a second revenue; and
bundling the set of contexts based upon the first revenue and the second revenue.

4. The method of claim 3, wherein said bundling the set of contexts based upon the first revenue and the second revenue comprises:
if the first revenue is greater than or equal to (≧) the second revenue
providing each context of the subset of contexts corresponding to the first agent separately, and
bundling the subset of contexts corresponding to an agent 2i with the subset of contexts corresponding to an agent 2i+1 for each i from 1 to n/2 to generate a first set of n/2 context bundles; and
if the second revenue is greater than the first revenue
bundling the subset of contexts corresponding to an agent 2i−1 with the subset of contexts corresponding to an agent 2i for each i from 1 to n/2 to generate a second set of n/2 context bundles.

5. The method of claim 4, wherein said enabling the at least one context bundle to be auctioned comprises:
if the first revenue is greater than or equal to (≧) the second revenue
separately selling each context of the subset of contexts corresponding to the first agent, and
separately selling each context bundle of the first set of n/2 context bundles; and
if the second revenue is greater than the first revenue
separately selling each context bundle of the second set of n/2 context bundles.

6. The method of claim 1, further comprising:
determining each valuation for a context of the set of contexts as a click through rate for the context multiplied by a value-per-click.

7. A sponsored search auction system, comprising:
a context bundler configured to bundle contexts related to a query, the context bundler being configured to receive a matrix of valuations that includes a valuation for each context of a set of contexts for each agent of a plurality of n agents, and to generate at least one context bundle that includes one or more contexts of the set of contexts based on the received matrix of valuations.

8. The sponsored search auction system of claim 7, wherein the context bundler is configured to calculate a first revenue according to:
$$first revenue = {\sum }_{j ∈ {A}_{1}} {s}_{j} + {\sum }_{i = 1}^{n / 2} {w}_{2 i + 1} ;$$
where
i=an agent of the plurality of n agents,
j=a context of the set of contexts in the matrix of valuations,
vᵢⱼ=a valuation of context j by agent i in the matrix of valuations,
hⱼ=a highest valuation for context j in the matrix of valuations,
sⱼ=a second highest valuation for context j in the matrix of valuations,
Aᵢ=a subset of the set of contexts for which an agent i has provided the highest valuation (s), and
wᵢ=a sum of highest context valuations hⱼ provided by agent i;
wherein the context bundler is configured to calculate a second revenue according to:
$$second revenue = {\sum }_{i = 1}^{n / 2} {w}_{2 i} ; and$$
wherein the context bundler is configured to compare the first revenue to the second revenue.

9. The sponsored search auction system of claim 7, wherein the context bundler comprises:
a first valuation determiner configured to determine a highest valuation in the matrix of valuations for each context of the set of contexts;
a second valuation determiner configured to determine a second highest valuation in the matrix of valuations for each context of the set of contexts;
a context subset determiner configured to determine a subset of contexts of the set of contexts corresponding to each agent of the plurality of n agents, the determined subset of contexts for an agent including any contexts of the set of contexts for which the agent has the determined highest valuation;
a first calculator configured to calculate for each agent of the plurality of n agents a total valuation of the corresponding subset of contexts;
an ordering module configured to number the plurality of n agents from an agent one (first agent) to an agent n in order of decreasing calculated valuation of the corresponding subset of contexts;
a second calculator configured to calculate for the first agent a sum of the determined second highest valuations for the subset of contexts corresponding to the first agent;
a first summer configured to sum the total valuations determined for odd numbered agents other than the first agent to determine a first sum;
a second summer configured to sum the first sum and the sum calculated for the first agent to determine a first revenue;
a third summer configured to sum the total valuations determined for even numbered agents to determine a second revenue; and
a bundling module configured to bundle the set of contexts based upon the first revenue and the second revenue.

10. The sponsored search auction system of claim 9, wherein the bundling module is configured to compare the first revenue to the second revenue;
wherein if the first revenue is greater than or equal to (≧) the second revenue, the bundling module is configured to leave each context of the subset of contexts corresponding to the first agent unbundled and to bundle the subset of contexts corresponding to an agent 2i with the subset of contexts corresponding to an agent 2i +1 for each i from 1 to n/2 to generate a first set of n/2 context bundles; and
wherein if the second revenue is greater than the first revenue, the bundling module is configured to bundle the subset of contexts corresponding to an agent 2i−1 with the subset of contexts corresponding to an agent 2i for each i from 1 to n/2 to generate a second set of n/2 context bundles.

11. The sponsored search auction system of claim 10, wherein said enabling the at least one context bundle to be auctioned comprising:
if the first revenue is greater than or equal to (≧) the second revenue
separately selling each context of the subset of contexts corresponding to the first agent, and
separately selling each context bundle of the first set of n/2 context bundles; and
if the second revenue is greater than the first revenue
separately selling each context bundle of the second set of n/2 context bundles.

12. The sponsored search auction system of claim 7, further comprising:
an input interface configured to receive valuations for the set of contexts from the agents to form the valuation matrix.

13. The sponsored search auction system of claim 7, further comprising:
an output interface configured to enable the agents to pay for the generated at least one context bundle.

14. A computer program product comprising a computer usable medium having computer readable program code means embodied in said medium for a query auction, comprising:
a first computer readable program code means for enabling a processor to receive a matrix of valuations that includes a valuation for each context of a set of contexts for each agent of a plurality of n agents;
a second computer readable program code means for enabling a processor to generate at least one context bundle that includes one or more contexts of the set of contexts based on the received matrix of valuations; and
a third computer readable program code means for enabling a processor to enable the at least one context bundle to be sold.

15. The computer program product of claim 7, wherein the second computer readable program code means comprises:
a fourth computer readable program code means for enabling a processor to calculate a first revenue according to:
$$first revenue = {\sum }_{j ∈ {A}_{1}} {s}_{j} + {\sum }_{i = 1}^{n / 2} {w}_{2 i + 1} ;$$
where
i=an agent of the plurality of n agents,
j=a context of the set of contexts in the matrix of valuations,
vᵢⱼ=a valuation of context j by agent i in the matrix of valuations,
hⱼ=a highest valuation for context j in the matrix of valuations,
sⱼ=a second highest valuation for context j in the matrix of valuations,
Aᵢ=a subset of the set of contexts for which an agent i has provided the highest valuation (s), and
wᵢ=a sum of highest context valuations hⱼ provided by agent i;
a fifth computer readable program code means for enabling a processor to calculate a second revenue according to:
$$second revenue = {\sum }_{i = 1}^{n / 2} {w}_{2 i} ; and$$
a sixth computer readable program code means for enabling a processor to compare the first revenue to the second revenue.

16. The computer program product of claim 14, wherein said second computer readable program code means comprises:
a fourth computer readable program code means for enabling a processor to determine a highest valuation in the matrix of valuations for each context of the set of contexts;
a fifth computer readable program code means for enabling a processor to determine a second highest valuation in the matrix of valuations for each context of the set of contexts;
a sixth computer readable program code means for enabling a processor to determine a subset of contexts of the set of contexts corresponding to each agent of the plurality of n agents, the determined subset of contexts for an agent including any contexts of the set of contexts for which the agent has the determined highest valuation;
a seventh computer readable program code means for enabling a processor to calculate for each agent of the plurality of n agents a total valuation of the corresponding subset of contexts;
a eighth computer readable program code means for enabling a processor to number the plurality of n agents from an agent one (first agent) to an agent n in order of decreasing calculated valuation of the corresponding subset of contexts;
a ninth computer readable program code means for enabling a processor to calculate for the first agent a sum of the determined second highest valuations for the subset of contexts corresponding to the first agent;
a tenth computer readable program code means for enabling a processor to sum the total valuations determined for odd numbered agents other than the first agent to determine a first sum;
a eleventh computer readable program code means for enabling a processor to sum the first sum and the sum calculated for the first agent to determine a first revenue;
a twelfth computer readable program code means for enabling a processor to sum the total valuations determined for even numbered agents to determine a second revenue; and
a thirteenth computer readable program code means for enabling a processor to bundle the set of contexts based upon the first revenue and the second revenue.

17. The computer program product of claim 16, wherein said thirteenth computer readable program code comprises:
a fourteenth computer readable program code means for enabling a processor to determine whether the first revenue is greater than or equal to (≧) the second revenue.

18. The computer program product of claim 17, wherein said thirteenth computer readable program code further comprises:
a fifteenth computer readable program code means for enabling a processor to provide each context of the subset of contexts corresponding to the first agent separately, and to bundle the subset of contexts corresponding to an agent 2i with the subset of contexts corresponding to an agent 2i+1 for each i from 1 to n/2 to generate a first set of n/2 context bundles if the first revenue is determined to be greater than or equal to (≧) the second revenue; and
a sixteenth computer readable program code means for enabling a processor to bundle the subset of contexts corresponding to an agent 2i−1 with the subset of contexts corresponding to an agent 2i for each i from 1 to n/2 to generate a second set of n/2 context bundles if the second revenue is determined to be greater than the first revenue.

19. The computer program product of claim 17, wherein said third computer readable program code means comprises:
a fifteenth computer readable program code means for enabling a processor to separately sell each context of the subset of contexts corresponding to the first agent, and to separately sell each context bundle of the first set of n/2 context bundles if the first revenue is determined to be greater than or equal to (≧) the second revenue; and
a sixteenth computer readable program code means for enabling a processor to separately sell each context bundle of the second set of n/2 context bundles if the second revenue is determined to be greater than the first revenue.
